(19) United States
(12) Patent Application Publication
(10) Pub. No.: US 2023/0285913 A1
(43) Pub. Date: Sep. 14, 2023

(54) MEMBRANE EMULSIFICATION APPARATUS WITH REFINER AND METHOD OF PREPARING A REFINED EMULSION

(71) Applicant: MICROPORE TECHNOLOGIES LIMITED, Cleveland (GB)

(72) Inventors: Sam Trotter, Cleveland (GB); Bruce Williams, Cleveland (GB)

(73) Assignee: MICROPORE TECHNOLOGIES LIMITED, Cleveland (GB)

(21) Appl. No.: 17/927,497

(22) PCT Filed: May 28, 2021
(86) PCT No.: PCT/GB2021/000062

§ 371 Date: Nov. 23, 2022

(30) Foreign Application Priority Data
May 28, 2020 (GB) 2008025.5

(51) Int. Cl. B01F 23/41; B01F 25/314; B01F 25/433; B01F 25/442; B01F 25/441

(52) U.S. Cl. CPC B01F 23/413; B01F 23/4105; B01F 25/31421; B01F 25/3141; B01F 25/4334; B01F 25/4422; B01F 25/4413

(57) ABSTRACT

Membrane Emulsification Apparatus with Refiner There is described a membrane emulsification apparatus for dispersing a first phase in a second phase, comprising: •a membrane defining a plurality of apertures connecting a first volume on a first side of the membrane to a second volume on a second, different, side of the membrane, the apparatus being arranged to receive a first phase containing a liquid in the first volume and to receive a second phase in the second volume the apparatus being adapted to generate an emulsion through egression of the first phase into the second phase via the plurality of apertures; •the apparatus also comprising a refiner (1) arranged to receive the emulsion from the membrane; and wherein said refiner comprises an inlet (4/5) and an outlet (5/4) wherein an opening (8) adapted to converge flow of the emulsion and to break up droplets of the emulsion into a refined emulsion is located between the inlet and the outlet.

### FIELD OF THE INVENTION

The present invention relates to membrane emulsification apparatus which includes a refiner.

More particularly, this invention relates to apparatus for dispersing a first phase in a second phase to generate an emulsion; and a refiner arranged to receive the emulsion and defining at least one variable opening to converge the flow of the emulsion to break up droplets of the first phase in the emulsion to generate a refined emulsion.

### BACKGROUND OF THE INVENTION

Apparatus and methods for generating emulsions of oil-in-water or water-in-oil; or multiple emulsions, such as water-oil-water and oil-water-oil; or dispersions of small sized capsules containing solids or fluids, are of considerable economic importance. Such apparatus and methods are used in a variety of industries, for example, for generating creams, lotions, pharmaceutical products, e.g. microcapsules for delayed release pharmaceutical products, pesticides, paints, varnishes, spreads and other foods.

In several instances, it is desirable to encase particles in a covering of another phase, such as a wall or shell material (microcapsules), to produce a barrier to the ingredient readily dissolving or reacting too quickly in its application. One such example is a delayed release pharmaceutical product.

In many applications it is desirable to employ a reasonably consistent droplet or dispersion, size.

By way of example only, in the case of a controlled release pharmaceutical product a narrow consistent microcapsule size can result in a predictable release of the encapsulated product; whereas a wide droplet size distribution can result in an undesirable rapid release of the product from fine particles (due to their high surface area to volume ratio) and a slow release from the larger particles. However, it will be understood that in some circumstances it may be desirable to have a controlled distribution of microcapsule size.

Current emulsion manufacturing techniques use systems comprising stirrers and homogenisers. In such systems a two phase dispersion with large droplets is forced though a high shear region near the stirrer, or through valves and nozzles to induce turbulence and thereby to break up the drops into smaller ones. However, it is not easily possible to control the droplet sizes achieved and the size range of droplet diameters is usually large. This is a consequence of the fluctuating degree of turbulence found in these systems and the exposure of the droplets to a variable shear field.

When manufacturing dispersions in which a semisolid is being produced there are additional disadvantages due to the highly non-Newtonian flow behaviour of the system in which high speed stirrers are only effective at distances close to the stirrer. Pressure drops are high with homogenisers and productivity is low, due to the nature of the high apparent viscosity of these systems. Hence, the energy consumption is also high. Also, such devices do not perform well when the moiety to be dispersed is a gel, or setting liquid, or if it contains solids. The equipment may become damaged by such products.

In recent years, there has been much research interest in the generation of emulsions using microfilter membranes. International patent application No. WO 01/45830 describes an apparatus for dispersing a first phase in a second phase using a rotating membrane.

UK Patent application No. 2505160 describes to membrane emulsification apparatus, comprising: a membrane provided with apertures connecting a first liquid phase on a first side of the membrane to a second phase on a second side of the membrane, for generating an emulsion through egression of the first phase into the second phase via the apertures. The emulsification apparatus includes a refiner arranged to receive the emulsion from the membrane, wherein said refiner includes an opening adapted to converge the flow of the emulsion to break up droplets of the first phase in the emulsion.

However, high concentrations can only be achieved by numerous recirculations of the emulsion through the opening. Also if the membrane emulsification apparatus is a single tank system then the number of passes (recirculations) that a droplet experiences is variable, so the distribution may broaden. The apparatus achieves emulsion droplets with a diameter of no greater than 20 μm.

We have now found an improved apparatus including a refiner which achieves, inter alia, high concentration emulsion, with emulsion droplet sizes of from about 70 nm to about 2 μm (starting from a large primary emulsion).

### SUMMARY OF THE INVENTION

An object of the present invention is to provide a membrane emulsification apparatus, which includes a refiner and is capable of emulsion droplets of about 70 nm-2 μm without the need for recirculation.

Thus, according a first aspect of the invention there is provided a membrane emulsification apparatus for dispersing a first phase in a second phase, comprising:
a membrane defining a plurality of apertures connecting a first volume on a first side of the membrane to a second volume on a second different side of the membrane, the apparatus being arranged to receive a first phase containing a liquid in the first volume and to receive a second phase in the second volume the apparatus being adapted to generate an emulsion through egression of the first phase into the second phase via the plurality of apertures;
the apparatus also comprising a refiner arranged to receive the emulsion from the membrane; and wherein said refiner comprises an inlet and an outlet wherein an opening is adapted to converge flow of the emulsion and to break up droplets of the emulsion into a refined emulsion is located between the inlet and the outlet.

The term refined emulsion will be understood by the person skilled in the art. Furthermore, herein the term refined emulsion shall mean a stable dispersion, of a first phase in a second phase. A refined emulsion as defined herein will generally comprise droplets with a diameter that may vary from about 250 nm to about <60 μm; preferably from about 1 μm to about 15 μm; more preferably from about 1 μm to about 10 μm; more preferably from about 1 μm to about 5 μm.

In one aspect of the present invention the refined emulsion as defined herein will generally comprise droplets with a diameter of from about 70 to about 250 nm. According to this aspect of the invention from about 80 to about 90% v/v of the refined emulsion droplets may have a diameter of from about 70 to about 250 nm.

In another aspect of the present invention the refined emulsion as defined herein will generally comprise droplets with a diameter of from about 1 to about 5 μm. According to this aspect of the invention from about 80 to about 90% v/v of the refined emulsion droplets may have a diameter of from about 1 to about 5 μm.

In a particular aspect of the invention the emulsification apparatus is for dispersing a first phase in a second phase, comprising: a membrane defining a plurality of apertures connecting a first volume on a first side of the membrane to a second volume on a second different side of the membrane, the apparatus being arranged to receive a first phase containing a liquid in the first volume and to receive a second phase in the second volume the apparatus being adapted to generate an emulsion through egression of the first phase into the second phase via the plurality of apertures.

The refined emulsion apparatus of the invention may be arranged so that flow of the second phase in the second volume creates a shear field at the area of egression of the first phase, the shear field being in a direction substantially perpendicular to the direction of egression of the first phase.

The membrane may be tubular in shape and may comprise a first end and a second end; wherein the first end is for receiving the second phase; and the refiner is coupled to the second end.

In one embodiment the refiner is tunable in that the opening is adjustable. A tunable refiner comprises adjustment means. In one embodiment of the invention the adjustment means comprises a differential screw.

According to this aspect of the invention the differential screw comprises a spindle with two external screw threads of differing thread pitch, and possibly opposite handedness, on which one or two nuts move. For example, as the spindle rotates it is moveable relative to the opening of the refiner. Generally, the first end of the spindle, adjacent the refiner opening, will be smaller than the second end of the spindle, which is distal to the refiner opening. Thus, the distal end of the spindle is provided with a first external thread, the diameter of which is wider than that of the end of the spindle adjacent the opening, which is provided with a second external thread. Thus, a coarse rotation of the spindle at the distal end causes a fine rotation of the spindle at the opening end, finely narrowing the opening and enabling the formation of a refined emulsion. The use of the one or two nuts move allows the position to be locked.

It will be understood that the first and second external threads may comprise opposite handedness or the first and second external threads may be generally congruous.

As herein described, the dimensions of opening may be varied by the use of a differential screw, such that the dimensions of the opening may be from about 1 μm to about 250 μm; preferably from about 1 μm to about 200 μm; more preferably from about 1 μm to about 150 μm; more preferably from about 1 μm to about 100 μm; or from about 5 μm to about 50 μm.

In another embodiment of the invention the refiner is a fixed refiner (as opposed to an adjustable refiner, i.e. a non-adjustable refiner). Such a fixed refiner may be suitable for larger scale, i.e. production, volumes. The use of a fixed refiner as herein described enables multiple passes in continuous flow to be made. Whereas in an adjustable refiner the droplet size may be controlled by adjustment or tuning of the opening, a fixed refiner may be controlled, inter alia, by changing the overall emulsion flow rate in a run. Alternatively, in a fixed refiner the opening may be adjusted by changing the dimensions of parts, i.e. between runs.

In a fixed refiner as herein described the dimensions of the opening may be adjusted by changing the dimensions of parts. The dimensions of the opening may vary depending upon, inter alia, the diameter of the plug, the size of the orifice, pressure, etc. Thus, the dimensions of the opening may be from about 1 μm to about 2 mm; preferably from about 1 μm to about 1 mm; more preferably from about 1 μm to about 500 μm; more preferably from about 1 μm to about 250 μm; more preferably from about 1 μm to about 200 μm; more preferably from about 1 μm to about 150 μm; more preferably from about 1 μm to about 100 μm; or from about 5 μm to about 50 μm.

The droplet size in the emulsion formed may vary depending upon, inter alia, the pressure in the refiner, e.g. the higher the pressure the smaller the drop size. Pressure is one factor in teens of its relation to the shear experience by emulsion droplets. However, the creation of extensional flow (e.g. stretching the drops into ligaments) may be a mechanism that allows the droplets to break up in the absence of high shear fields. There are limitations on pressure, for example, due to the mechanical strength of clamps. However, generally the pressure will be in the region of from about 5 bar (5×10⁵ Pa) to about 30 bar (30×10⁵ Pa).

The refiner may be coupled to the second end of the membrane (i.e. opposite the first end of the membrane) and includes one or more openings therein having dimensions (e.g. diameter) in the range of from about 1 μm to about 2 mm as herein described. In one embodiment, the refiner may initially be a separate component to the membrane and may be subsequently coupled to the membrane, e.g. via welding or an adhesive for example. In another embodiment, the refiner may be manufactured as an integral part of the membrane and therefore not require coupling to the second end of the membrane.

The refiner is arranged to receive the emulsion from the membrane and converge the flow of the emulsion to break up (i.e. reduce in size) droplets of the first phase in the emulsion to create a refined emulsion. In particular, the one or more openings of the refiner causes convergence of the flow of the emulsion which results in attrition between the droplets of the first phase within the emulsion causing them to break up into a refined emulsion.

In general, the adjustable opening of the refiner will comprise a refiner plug adjacent the opening, such that movement of the insert rod closer to the opening will reduce the size of the opening. Thus, the end of the insert adjacent to the opening will generally comprise a frusto conical member with a terminal protrusion. The terminal protrusion will generally comprise a flat end surface. However, it is within the scope of the present invention for the terminal protrusion is adapted to simulate multiple passes of the emulsion through the opening, whilst in fact only a single pass is made. Thus, one example of a means of simulating multiple passes is to provide a terminal rod that is stepped. When the terminal rod that is stepped need the opposing surface may be conical. The use of a stepped terminal rod has the effect of presenting the opening of the refiner with consecutive surfaces.

Furthermore, a longer smaller opening may be utilised, rather than a sharp edged opening. The use of such a longer smaller opening may encourage extensional flow (stretching the droplets into ligaments). Such a longer smaller opening may comprise two cones of different angle, such that the inlet end has equal or larger cross sectional area than the outlet end, thus speeding up and stretching the droplets. In addition, the surfaces may be roughened, e.g. with circular grooves to induce waves on the stretched ligaments.

In one aspect of the invention the apparatus may be provided with a first pump for providing the first phase to the first volume under pressure, and optionally a second pump for providing the second phase to the second volume under pressure. Furthermore, the apparatus may be provided with an emulsion pump, in order to generate high pressure at the opening. The use of such an emulsion pump may be advantageous by providing more shear at the opening to break up the emulsion droplets egressing through the opening to provide a refined emulsion.

When a pump is provided the pump may be integral to the refiner assembly or the membrane assembly. Alternatively, the pump may be separate from the refiner assembly and the membrane assembly. The use of a separate pump, inter alia, enables a coarse emulsion generated by membrane emulsification to be refined.

In one aspect of the invention the membrane emulsification apparatus comprises a cross-flow assembly as described in International patent application No. WO 2019/092461, which is incorporated herein by reference.

Thus, according a further aspect of the invention there is provided membrane emulsification apparatus for dispersing a first phase in a second phase, wherein the membrane emulsification apparatus comprises a cross-flow apparatus for producing an emulsion or dispersion by dispersing a first phase in a second phase; said cross-flow apparatus comprising:
an outer tubular sleeve provided with a first inlet at a first end; an emulsion outlet; and a second inlet, distal from and inclined relative to the first inlet;
a tubular membrane provided with a plurality of pores and adapted to be positioned inside the tubular sleeve; and
optionally an insert adapted to be located inside the tubular membrane, said insert comprising an inlet end and an outlet end, each of the inlet end and an outlet end being provided with chamfered region; the chamfered region is provided with a plurality of orifices and a furcation plate;
the apparatus also comprising a refiner arranged to receive the emulsion from the membrane and wherein said refiner comprises an inlet and an outlet wherein an adjustable opening adapted to converge flow of the emulsion and to break up droplets of the emulsion into a refined emulsion is located between the inlet and the outlet.

The apparatus of the invention is advantageous because, inter alia, its use is capable of achieving a high concentration uniform emulsion, with emulsion droplet sizes of from about 250 nm to about <60 μm, e.g. from about 70 to about 250 nm or from about 1 to about 5 μm. The apparatus of the invention is further advantageous because, inter alia, the apparatus may be readily disassembled for cleaning and inspection; it uses seals suitable for aseptic operation, and is designed for GMP manufacturing.

Furthermore, the use of the apparatus of the invention which includes a refiner may further be advantageous because, inter alia, it may be capable of achieving a desired emulsion droplet size range when using a membrane with larger pores, which are generally less expensive than membranes with smaller pore, wherein the refiner enable the desired smaller droplet sizes, e.g. from about 10 to about 30 μm to be achieved. In addition, use of a membrane with larger pores may also be advantageous for dealing with suspended solids, e.g. needle crystals, or liquid crystals.

Droplet size uniformity is expressed in terms of the coefficient of variation (CV):

$$C V = \frac{σ}{μ} \times 100 \qquad ( 8 )$$

where σ is the standard deviation and μ is the mean of the volume distribution curve.

The apparatus of the present invention is advantageous in that, inter alia, it enables refined emulsion droplets to be prepared with a CV of from about 5% to about 50%, or from about 5% to about 40%, or from about 5% to about 30%, or from about 5% to about 20%, e.g. from about 10% to about 15%.

The apparatus of the present invention is further advantageous because it is capable of being used to prepare a uniform refined emulsion as herein defined, with a single pass of the emulsion through the refiner, i.e. without the need for recirculation or multiple passes of the emulsion, to produce a refined emulsion. However, it is within the scope of the present invention to use the apparatus whilst employing multiple passes (recirculations), for example, when multiple passes are utilised 2-5, e.g. 2, 3, 4 or 5 passes may be utilised. The use of multiple passes (recirculations) may reduce the number of larger droplets formed, e.g. the proportion of large or oversized droplets may be reduced, without a significant impact on the mean droplet size. Whilst the use of fewer passes (recirculations) may minimize the overall pressure requirement.

In another embodiment the need for multiple passes (recirculations) can be mitigated by providing a refiner which has multiple stages, each geometrically similar to one another. Thus, passing droplets through the multiple stages of the refiner provides a similar effect to making multiple passes in a single refiner. However, the use of a multiple stage refiner may be advantageous because, inter alia, continuous operation may be possible. It will generally be understood that the more stages present in a refiner the higher the required inlet pressure. Therefore, an optimum number of stages in a multiple stages refiner is about 2-5, e.g. 2, 3, 4 or 5 stages may be utilised. Use of a multiple stages refiner may also provide a narrower droplet size distribution.

The apparatus of the invention may be operated in a batch mode or a continuous mode. Preferably, the apparatus is operated in a continuous mode. The use of consistent residence times in continuous mode and/or the use of short residence times may be advantageous in preparing refined droplets. The use of a continuous mode may be advantageous when preparing “core-shell” droplets or microparticles, e.g. polymer shells, which may be useful in pharmaceutical and biomedical applications, such as, cell encapsulation, targeted drug delivery, controlled drug release, etc.

The refined emulsion of the invention may be prepared essentially free of any emulsifiers. It is an object of the present invention to provide an improved method for forming a refined emulsion, which may be essentially free of any emulsifiers.

A further object of this invention is to provide a method for forming a unique class of refined emulsions, e.g., those with a droplet size of 0.1-5 μm, formed without emulsifiers, which offer the possibility of their being employed in unique commercial applications and processes.

The generation of a uniform refined emulsion (droplet size of 0.1-5 μm), formed without emulsifiers, renders the apparatus of the invention to be suitable for a variety of uses, including, inter alia, the formulation of creams, lotions, pharmaceutical products, e.g. microcapsules for delayed release pharmaceutical products, pesticides, paints, varnishes, spreads and other foods, such as a chocolate products.

According to a further aspect of the invention there is provided a method of preparing a refined emulsion, i.e. an emulsion with a droplet size of from about 0.1-5 μm, using an apparatus as herein described.

According to this aspect of the invention the method comprises:
providing a first phase to the first volume of the apparatus;
providing a second phase to the second volume of the apparatus;
causing the egression of the first phase into the second phase via a plurality of apertures in a membrane to preparing an emulsion;
passing the emulsion through an inlet of a refiner and converging the flow of the emulsion through an adjustable opening to break up droplets of the emulsion into a refined emulsion.

According to a yet further aspect of the invention there is provided a refined emulsion prepared using a method as herein described.

The present invention will now be described by way of example only, with reference to the accompanying figures in which:

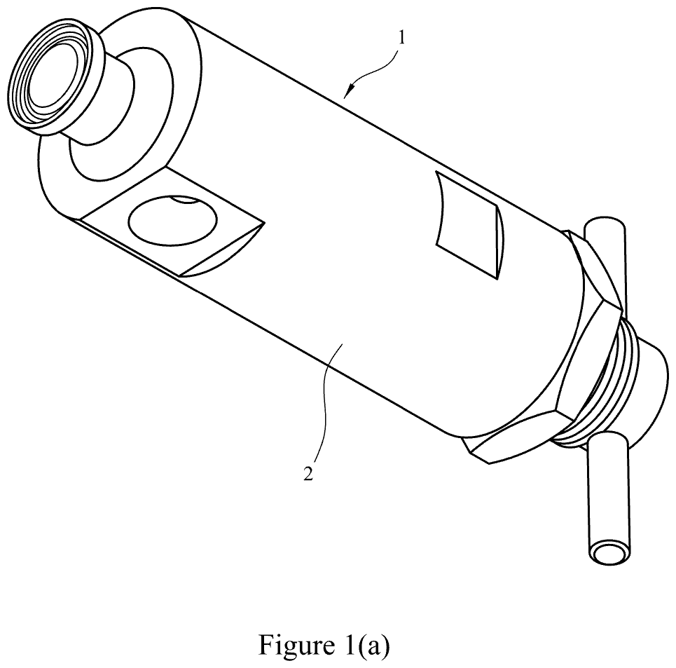

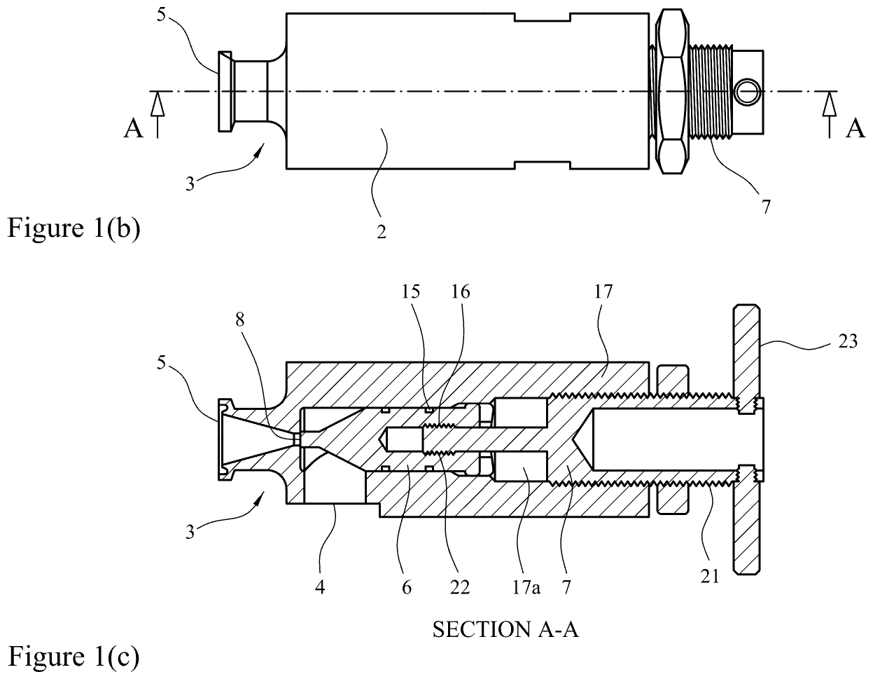

FIG. 1(a)-(c) illustrates the membrane emulsification apparatus refiner of the invention;

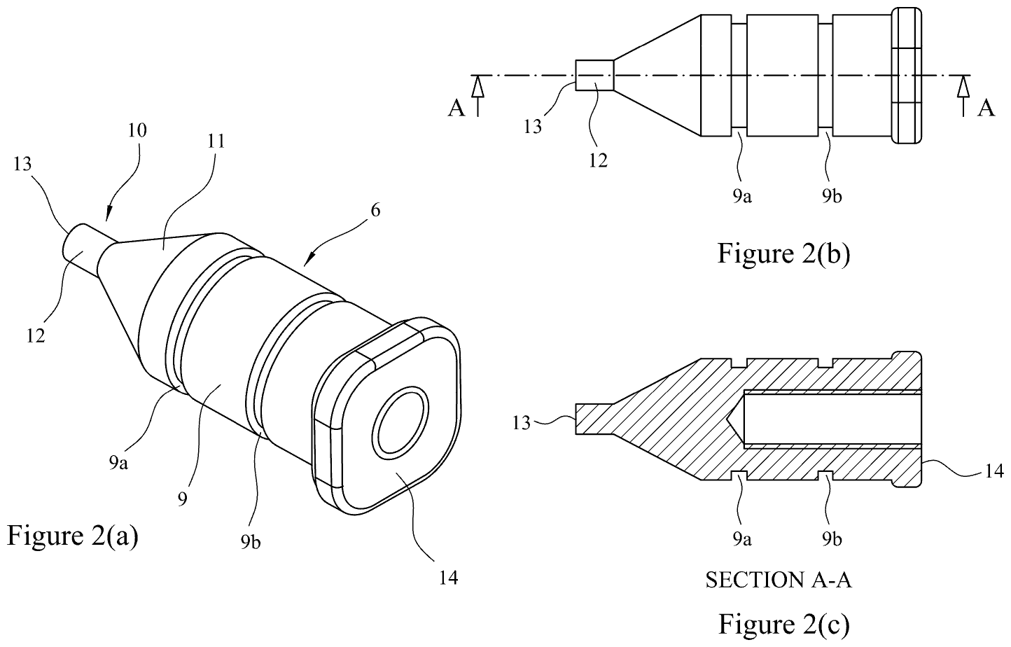

FIG. 2(a)-(c) illustrates a refiner plug;

FIGS. 3(a) and (b) illustrates an adjustment means, as a differential screw;

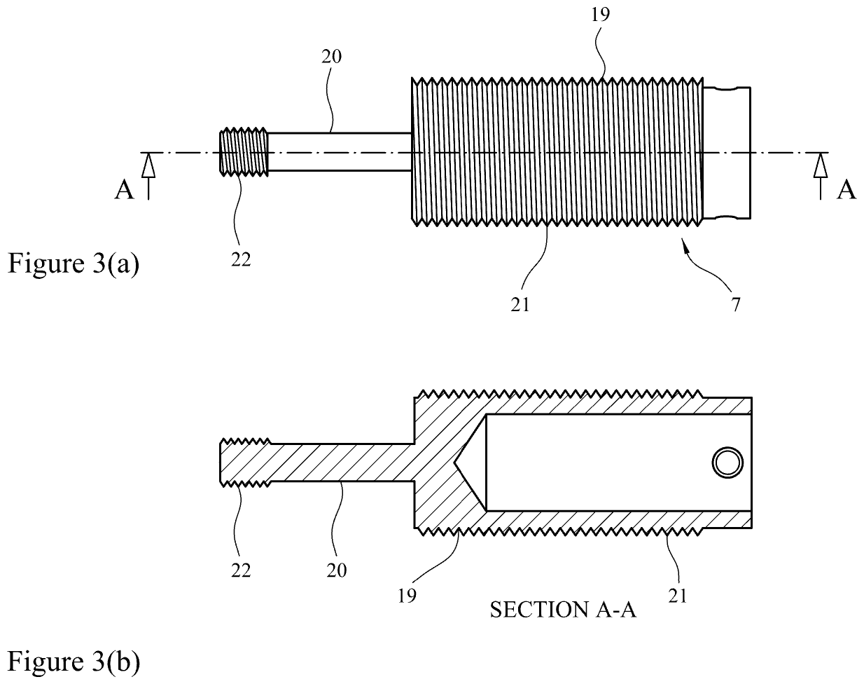

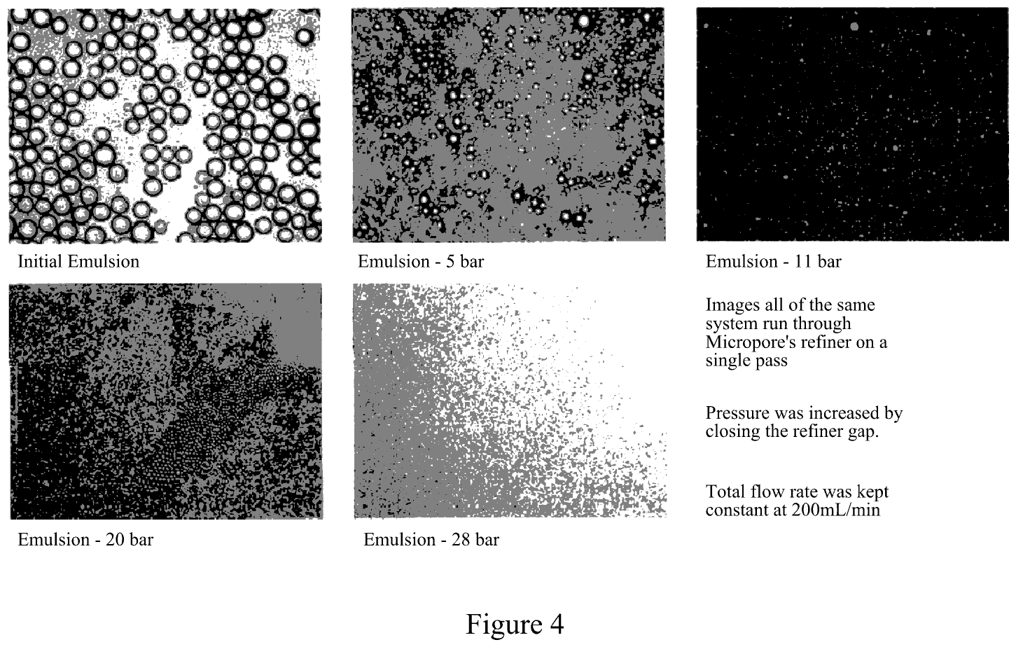

FIG. 4(a)-(e) illustrates refined emulsions formed according to the invention;

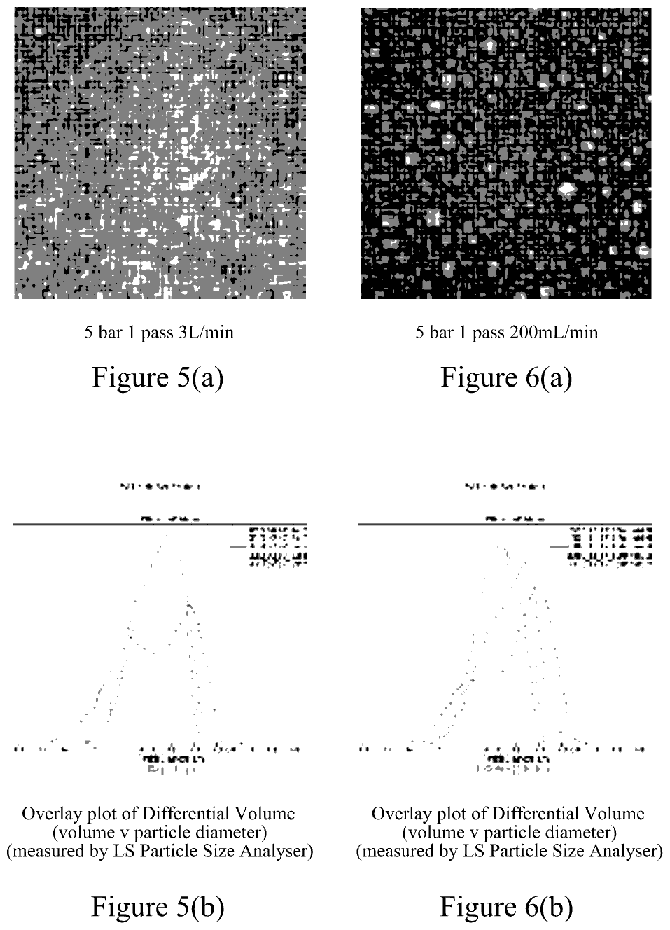

FIG. 5(a) illustrates refined emulsions formed at 5 bar with 1 pass at 3 L/min;

FIG. 5(b) is an overlay plot of Differential Volume (volume v particle diameter) (measured by LS Particle Size Analyser);

FIG. 6(a) illustrates refined emulsions formed at 5 bar with 1 pass at 200 mL/min;

FIG. 6(b) is an overlay plot of Differential Volume (volume v particle diameter) (measured by LS Particle Size Analyser);

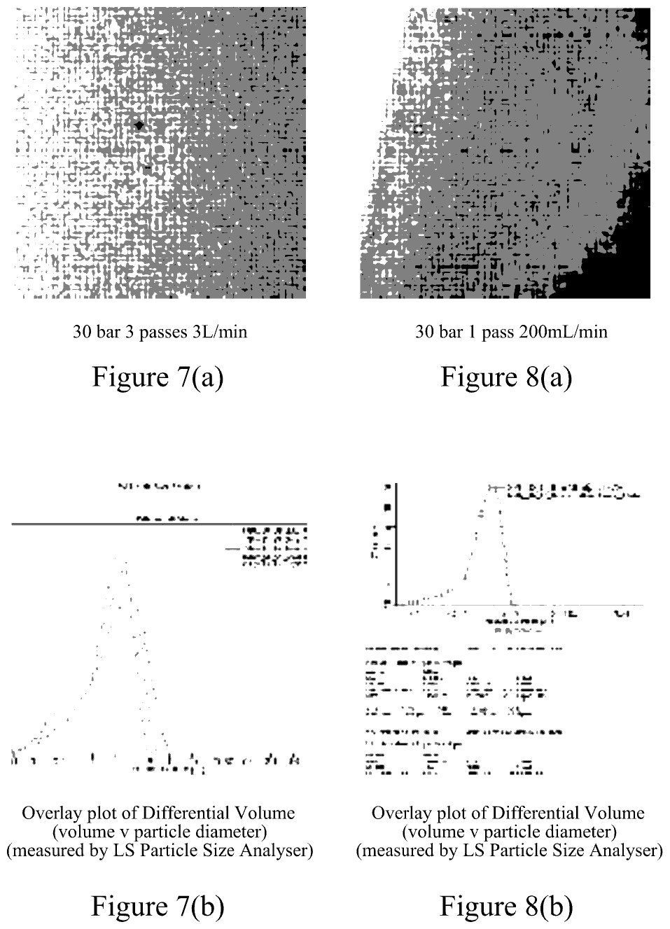

FIG. 7(a) illustrates refined emulsions formed at 30 bar with 3 passes at 3 L/min;

FIG. 7(b) is an overlay plot of Differential Volume (volume v particle diameter) (measured by LS Particle Size Analyser);

FIG. 8(a) illustrates refined emulsions formed at 30 bar with 1 pass at 200 mL/min;

FIG. 8(b) is an overlay plot of Differential Volume (volume v particle diameter) (measured by LS Particle Size Analyser);

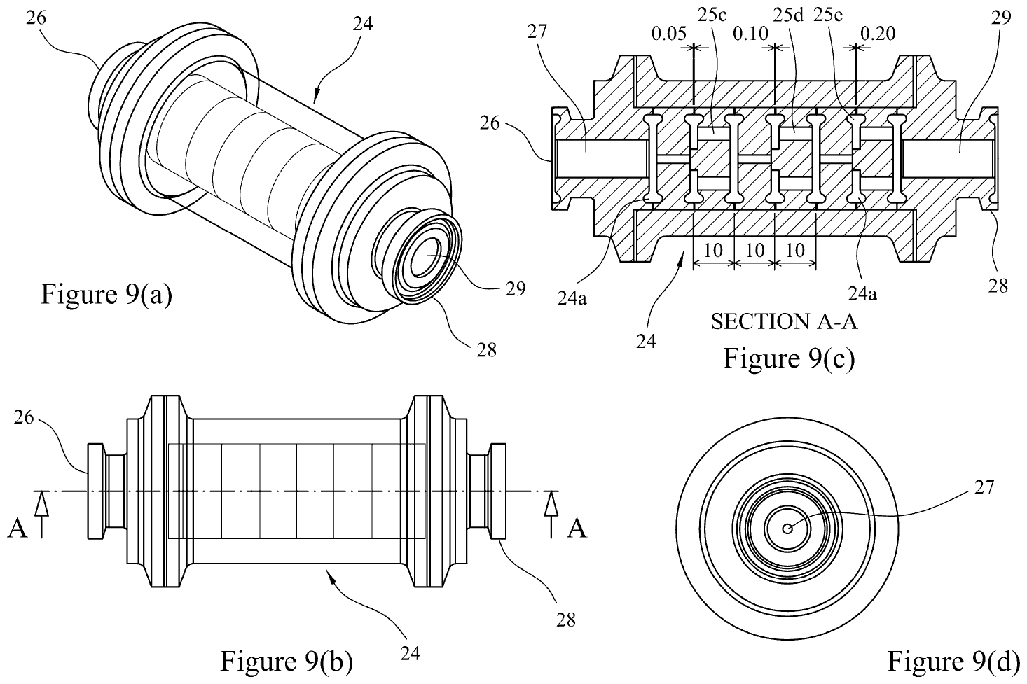

FIGS. 9(a)-(d) illustrate a fixed refiner with multiple stages;

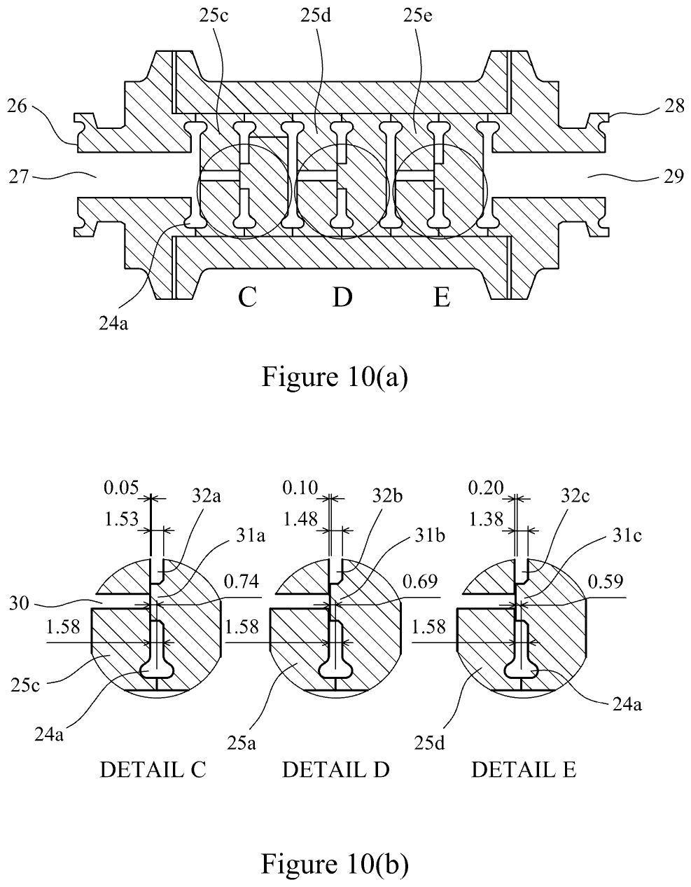

FIGS. 10(a) and (b) are cross-sections of a fixed refiner with multiple stages;

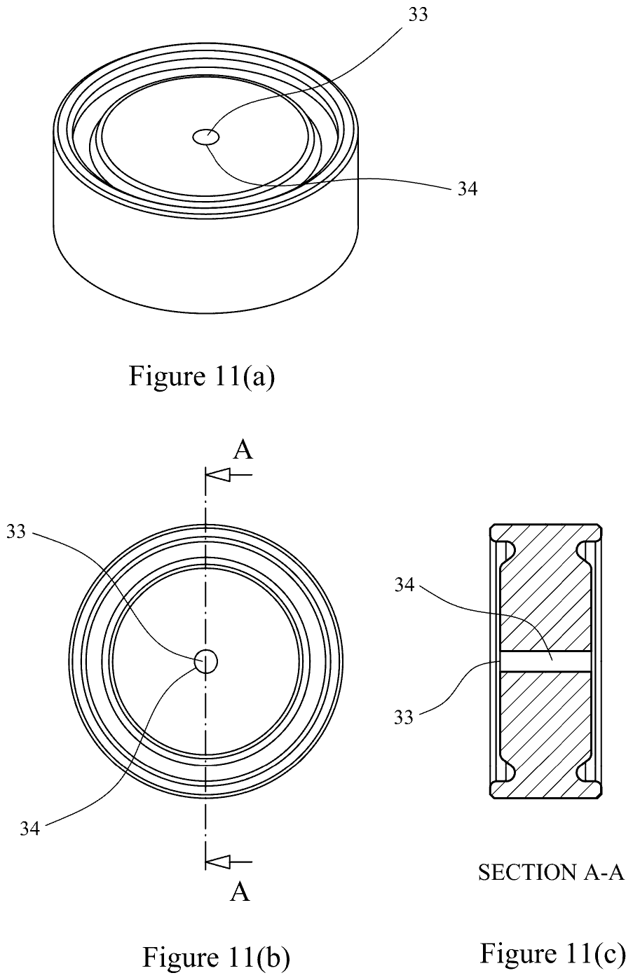

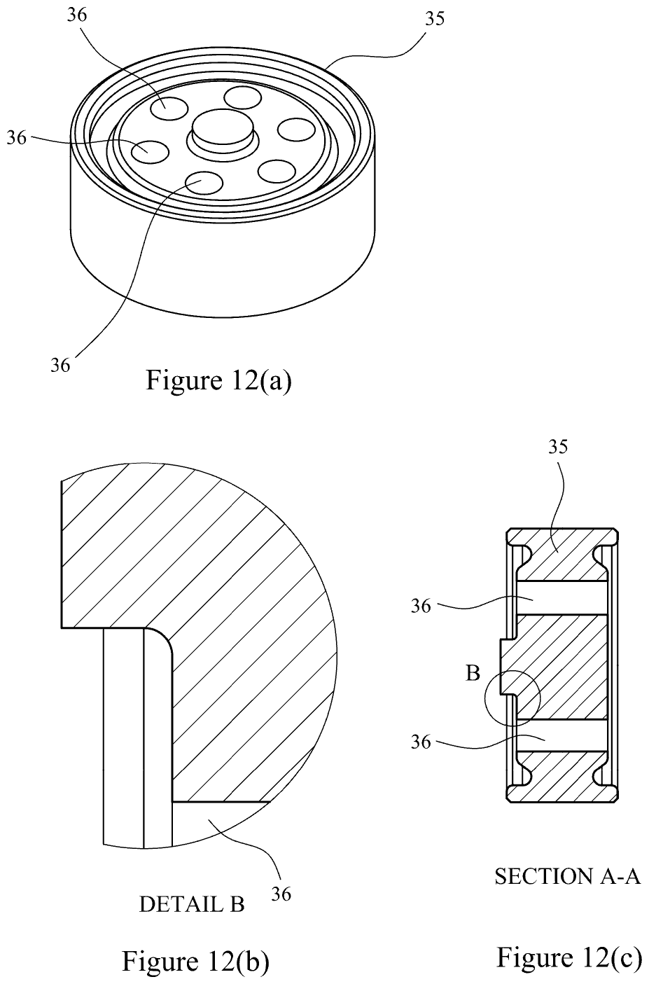

FIGS. 11(a)-(c) illustrate a single inlet/outlet port for use with a fixed refiner; FIGS. 12(a)-(c) illustrate a multiple inlet/outlet port for use with a fixed refiner;

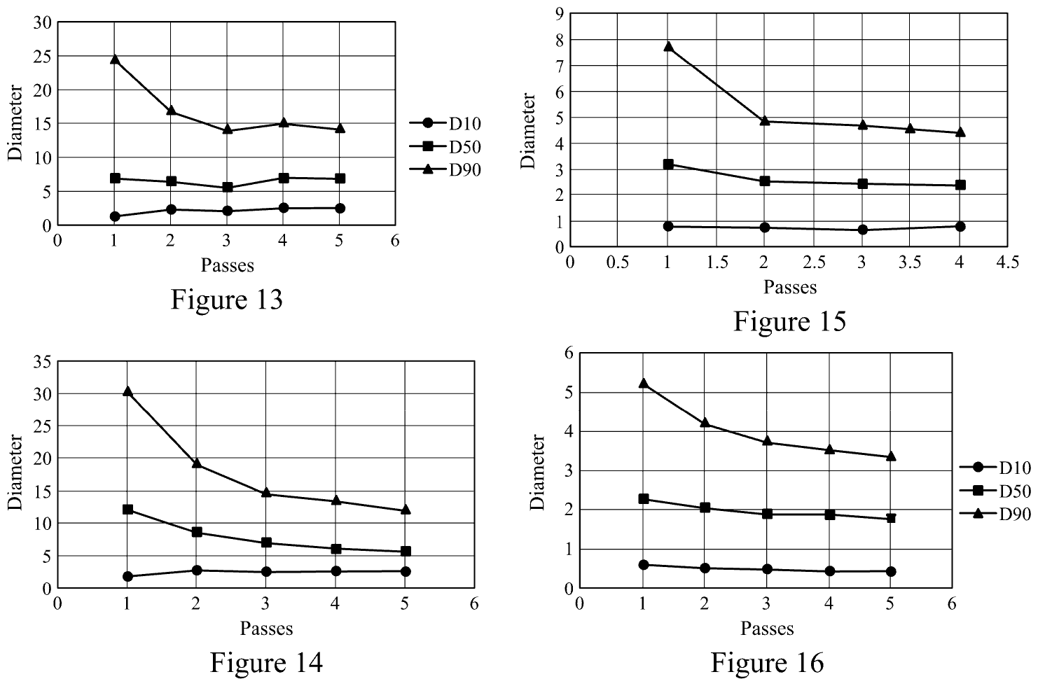

FIG. 13 illustrates the change of particle diameters using multiple passes of a refiner at 5 bar input pressure at a flow rate of 3 Litres/min.;

FIG. 14 illustrates the change of particle diameters using multiple passes of a refiner at 5 bar input pressure at a flow rate of 200 ml/min.;

FIG. 15 illustrates the change of particle diameters using multiple passes of a refiner at 30 bar input pressure at a flow rate of 200 ml/min.; and

FIG. 16 illustrates the change of particle diameters using multiple passes of a refiner at 30 bar input pressure at a flow rate of 3 Litres/min.

In the figures herein the following numbering has been used:

| | |
|---|---|
| 1 | membrane emulsification refiner apparatus |
| 2 | tunable refiner |
| 3 | first end |
| 4 | outlet/inlet |
| 5 | inlet/outlet |
| 6 | refiner plug |
| 7 | differential screw |
| 8 | opening |
| 9 | refiner plug body |
| 9a and 9b | circumferential grooves |
| 10 | first end of refiner plug body |
| 11 | frusto conical member |
| 12 | terminal protrusion |
| 13 | flat end surface |
| 14 | second end of refiner plug |
| 15 | internal longitudinal chamber |
| 16 | internal screw thread |
| 17 | second end of tunable refiner |
| 17a | internal longitudinal chamber |
| 18 | internal screw thread |
| 19 | differential screw body |
| 20 | spindle |
| 21 | body external screw thread |
| 22 | spindle external screw thread |
| 23 | screw turn handle |
| 24 | fixed refiner |
| 24(a) | sanitary gasket groove |
| 25(c-e) | multiple stages |
| 26 | inlet/outlet |
| 27 | single inlet/outlet orifice |
| 28 | outlet/inlet |
| 29 | single outlet/inlet orifice |
| 30 | stage inlet/outlet |
| 31 | stage opening/gap |
| 31(a-c) | stage plug |
| 32(a-c) | stage outlet/inlet |
| 33 | refiner single inlet/outlet port |
| 34 | refiner single orifice |
| 35 | refiner inlet/outlet port |
| 36 | radially space orifices |

Referring to FIGS. 1(a)-(c), 2(a)-(c), 3(a) and 3(b); membrane emulsification apparatus 1 comprises a membrane emulsifier (not shown) and a tunable refiner 2. At a first end 3, the tunable refiner 2 comprises an inlet 5, an outlet 4, a refiner plug 6 and a differential screw 7. Between the inlet 5 and outlet 4 an opening 8 is located.

The refiner plug 6 comprises a body 9; which at a first end 10, adjacent the opening 8, comprises a frusto conical member 11 with a terminal protrusion 12. The terminal protrusion 12 comprises a flat end surface 13, such that the flat end surface 13 substantially abuts the opening 8. The body 9 of the refiner plug 6 may be provided with one or more circumferential grooves 9a and 9b. The one or more circumferential grooves 9a and 9b are each adapted to house a seal, e.g. in the form of an O-ring (not shown).

A second end 14 of the refiner plug 6, distal from the opening 8, is provided with an internal longitudinal chamber 15. The internal longitudinal chamber 15 is provided with an internal screw thread 16.

A second end 17, the tunable refiner 2 is provided with an internal longitudinal chamber 17a. The internal longitudinal chamber 17a is provided with an internal screw thread 18.

The differential screw 7 comprises a body 19 and a spindle 20. The body 19 is provided with an external screw thread 21; and the spindle 20 is provided with an external screw thread 22.

External screw thread 21 of the differential screw body 19 is adapted to engage with internal screw thread 18 of the tunable refiner 2; and external screw thread 22 of the spindle 20 is adapted to engage with internal screw thread 16 of the refiner plug 6.

The differential screw 7 is provided with a turn handle 23.

In operation the opening 8 is adjustable by fine movement of the refiner plug 6 with the terminal protrusion 12 and the flat end surface 13 which substantially abuts the opening 8. A rotation of the handle 23 of the differential screw 7 translates to a fine movement of the flat end surface 13 of the terminal protrusion 12; and a fine adjustment of the opening 8.

Referring to FIG. 4 an emulsion formed by a membrane without a refiner s illustrated in FIG. 4(a). FIGS. 4(b)-4(e) illustrate refined emulsions formed from a single pass of the emulsion through the refiner. Pressure was increased by closing the gap in the opening. FIG. 4(b) illustrates a refined emulsion at 5 bar (5×10⁵ Pa) (refiner inlet pressure); FIG. 4(c) illustrates a refined emulsion at 11 bar (11×10⁵ Pa) (refiner inlet pressure); FIG. 4(d) illustrates a refined emulsion at 20 bar (2×10⁶ Pa) (refiner inlet pressure); and FIG. 4(e) illustrates a refined emulsion at 28 bar (2.8×10⁶ Pa) (refiner inlet pressure).

Referring to FIGS. 9(a)-(d), 10(a) and (b); a fixed refiner 24 is provided with multiple stages 25(c-e). The fixed refiner 24 is provided with an inlet 26, with a single orifice 27, and an outlet 28 with a single orifice 29. Each stage is provided with an annular groove or a pair of annular grooves 24(a) adapted for housing a sanitary gasket. The refiner illustrated comprises three refiner stages. However, it will be understood that the number of refiner stages may be varied and therefore the number illustrated should not be considered to be limiting.

The inlet 26 connects with a first stage 25(c) of the refiner 24 and the outlet 28 connects with a third stage 25(e) of the refiner 24. Each of stages 25(a), (b) and (c) is provided with an inlet 30 (a), (b) and (c) respectively, an opening 31 (a), (b) and (c) adjacent to plug 31 (a), and an outlet 32 (a), (b) and (c).

FIG. 10 (b) illustrates how the how the refiner can be configured to different size openings 31 are progressively larger, 0.05 mm, 0.10 mm and 0.20 mm, relative to plugs 31 (a-c). Such that, in use, an emulsion to be refined (not shown) will pass through the refiner with suitably configured stages from stage (a) to stage (c) (or from stage (c) to stage (a)) and consequently the emulsion droplets will be progressively refined. It is within the scope of the present invention for stages (a-c) to be varied. For example, if a broader size distribution is desirable then the configuration of stages (a-c) may be altered, or more or fewer stages may be included, or the size of the openings and/or the plugs may be varied.

An important aspect of the multiple stage refiner s the diameter of the inlet orifice (which may affect the velocity of an emulsion); the gap/opening adjacent the plug and/or the plug diameter (which may affect the pressure differential/velocity/shear).

Referring to FIGS. 11(a)-(c); a single inlet/outlet port 33 for use with a fixed refiner (not shown). The single inlet/outlet port 33 is provided with a single, substantially central, orifice 34.

Referring to FIGS. 12(a)-(c); an inlet/outlet port 35 is provided with a plurality of radially spaced orifices 36. The plurality of radially spaced orifices 36 ensures that flow distributes evenly around circumference of the plug 31(a-c) and the opening/gap 31.

### EXAMPLE 1

Using a Beckman Coulter LS particle size analyser droplet production was carried out, starting from a large primary emulsion, varying the flow rate and the size of the adjustable opening of the refiner body and the refiner plug. The results are illustrated in Table 1.

TABLE 1

| Flow Rate | Pressure | Distance |
|---|---|---|
| (mL/min) | (bar) | (um) |
| 500 | 5 | 17 |
| 500 | 30 | 7 |
| 3000 | 5 | 99 |
| 3000 | 30 | 41 |
| 7500 | 5 | 238 |
| 7500 | 30 | 101 |

### EXAMPLE 2

Using multiple passes of a refiner at 5 bar input pressure at a flow rate of 3 Litres/min., the change of the diameter of the particles was measured using a Beckman Coulter LS particle size analyser. The results are illustrated in Table 2 and FIG. 13.

TABLE 2

| | | % | | | % | | | % |
|---|---|---|---|---|---|---|---|---|
| Pass | D10 | Change | D25 | D50 | Change | D75 | D90 | Change |
| 1 | 1.371 | | 2.623 | 6.843 | | 15.92 | 24.32 | |
| 2 | 2.381 | 73.66885 | 3.69 | 6.514 | −4.80783 | 11.69 | 16.79 | −30.9622 |
| 3 | 2.209 | −7.22386 | 3.383 | 5.621 | −13.7089 | 9.653 | 14.02 | −16.4979 |
| 4 | 2.585 | 17.02128 | 4.052 | 6.972 | 24.03487 | 11.19 | 14.97 | 6.776034 |
| 5 | 2.627 | 1.624758 | 4.09 | 6.86 | −1.60643 | 10.69 | 14.1 | −5.81162 |

### EXAMPLE 3

Using multiple passes of a refiner at 5 bar input pressure at a flow rate of 200 ml/min., the change of the diameter of the particles was measured using a Beckman Coulter LS particle size analyser. The results are illustrated in Table 3 and FIG. 14.

TABLE 3

| | | % | | | % | | | % |
|---|---|---|---|---|---|---|---|---|
| Pass | D10 | Change | D25 | D50 | Change | D75 | D90 | Change |
| 1 | 1.786 | | 4.114 | 11.94 | | 21.03 | 30.26 | — |
| 2 | 2.868 | 60.58231 | 4.726 | 8.658 | −27.4874 | 14 | 19.1 | −36.8804 |
| 3 | 2.667 | −7.00837 | 4.15 | 6.988 | −19.2885 | 11.01 | 14.68 | −23.1414 |
| 4 | 2.498 | −6.33671 | 3.832 | 6.23 | −10.8472 | 9.761 | 13.23 | −9.87738 |
| 5 | 2.378 | −4.80384 | 3.609 | 5.699 | −8.52327 | 8.792 | 12.03 | −9.07029 |

### EXAMPLE 4

Using multiple passes of a refiner at 30 bar input pressure at a flow rate of 200 ml/min., the change of the diameter of the particles was measured using a Beckman Coulter LS particle size analyser. The results are illustrated in Table 4 and FIG. 15.

TABLE 4

| | | % | | | % | | | % |
|---|---|---|---|---|---|---|---|---|
| Pass | D10 | Change | D25 | D50 | Change | D75 | D90 | Change |
| 1 | 0.799 | | 1.772 | 3.178 | | 5.062 | 7.728 | |
| 2 | 0.754 | −5.63204 | 1.522 | 2.52 | −20.7048 | 3.696 | 4.844 | −37.3188 |
| 3 | 0.66 | −12.4668 | 1.452 | 2.431 | −3.53175 | 3.567 | 4.687 | −3.24112 |
| 4 | 0.774 | 17.27273 | 1.538 | 2.411 | −0.82271 | 3.421 | 4.413 | −5.84596 |

### EXAMPLE 5

Using multiple passes of a refiner at 30 bar input pressure at a flow rate of 3 Litres/min, the change of the diameter of the particles was measured using a Beckman Coulter LS particle size analyser. The results are illustrated in Table 5 and FIG. 16.

TABLE 5

| | | % | | | % | | | % |
|---|---|---|---|---|---|---|---|---|
| Pass | D10 | Change | D25 | D50 | Change | D75 | D90 | Change |
| 1 | 0.595 | | 1.213 | 2.286 | | 3.728 | 5.231 | |
| 2 | 0.521 | −12.437 | 1.161 | 2.087 | −8.70516 | 3.163 | 4.206 | −19.5947 |
| 3 | 0.481 | −7.67754 | 1.064 | 1.93 | −7.52276 | 2.857 | 3.74 | −11.0794 |
| 4 | 0.451 | −6.23701 | 1.043 | 1.869 | −3.16062 | 2.726 | 3.524 | −5.7754 |
| 5 | 0.433 | −3.99113 | 1.002 | 1.801 | −3.63831 | 2.603 | 3.344 | −5.10783 |

1. A membrane emulsification apparatus for dispersing a first phase in a second phase, comprising:
a membrane defining a plurality of apertures connecting a first volume on a first side of the membrane to a second volume on a second, different, side of the membrane, the apparatus being arranged to receive a first phase containing a liquid in the first volume and to receive a second phase in the second volume the apparatus being adapted to generate an emulsion through egression of the first phase into the second phase via the plurality of apertures;
the apparatus also comprising a refiner arranged to receive the emulsion from the membrane; and wherein said refiner comprises an inlet and an outlet wherein an opening adapted to converge flow of the emulsion and to break up droplets of the emulsion into a refined emulsion is located between the inlet and the outlet;
wherein the opening is adjustable and the opening comprises adjustment means, such that the refiner is tunable by adjustment of the opening.

2.-11. (canceled)

12. Membrane emulsification apparatus according to claim 1 wherein the adjustment means in the tunable refiner comprises a differential screw.

13. Membrane emulsification apparatus according to claim 12 wherein the differential screw comprises a spindle with two external screw threads of differing thread pitch.

14. Membrane emulsification apparatus according to claim 12 wherein the differential screw comprises a spindle with two external screw threads are generally congruous.

15. Membrane emulsification apparatus according to claim 12 wherein the differential screw comprises a spindle with two external screw threads of differing handedness.

16. Membrane emulsification apparatus according to claim 12 wherein nuts are located around two external screw threads of the differential screw.

17. Membrane emulsification apparatus according to claim 13 wherein the first end of the spindle, adjacent the refiner opening, is smaller than the second end of the spindle, which is distal to the refiner opening.

18. Membrane emulsification apparatus according to claim 17 wherein the distal end of the spindle is provided with a first external thread, the diameter of which is wider than that of the end of the spindle adjacent the opening, which is provided with a second external thread.

19.-24. (canceled)

25. Membrane emulsification apparatus according to claim 1 wherein the refiner is integral to the membrane.

26. Membrane emulsification apparatus according to claim 1 wherein the adjustable opening comprises a refiner plug adjacent the opening, such that movement of the insert rod closer to the opening reduces the size of the opening.

27. Membrane emulsification apparatus according to claim 26 wherein the end of the insert rod adjacent to the opening comprises a frusto conical member with a terminal protrusion.

28. Membrane emulsification apparatus according to claim 27 wherein the terminal protrusion comprises a flat end surface.

29. Membrane emulsification apparatus according to claim 26 wherein the insert rod is adapted to simulate multiple passes of the emulsion through the opening.

30. (canceled)

31. (canceled)

32. Membrane emulsification apparatus according to claim 1 wherein the apparatus is used in a continuous mode.

33. Membrane emulsification apparatus according to claim 32 wherein the refiner comprises multiples inlets and/or multiple outlets.

34.-45. (canceled)

46. A method of preparing a refined emulsion, said method comprising using a membrane emulsification apparatus according to claim 1.

47. A method of preparing a refined emulsion according to claim 46 wherein the method comprises providing a first phase to the first volume of the apparatus;
providing a second phase to the second volume of the apparatus;
causing the egression of the first phase into the second phase via a plurality of apertures in a membrane to preparing an emulsion;
passing the emulsion through an inlet of a refiner and converging the flow of the emulsion through an adjustable opening to break up droplets of the emulsion into a refined emulsion.

48. A method of preparing a refined emulsion according to claim 46 wherein the membrane emulsification apparatus for dispersing a first phase in a second phase, comprises:
a membrane defining a plurality of apertures connecting a first volume on a first side of the membrane to a second volume on a second, different, side of the membrane, the apparatus being arranged to receive a first phase containing a liquid in the first volume and to receive a second phase in the second volume the apparatus being adapted to generate an emulsion through egression of the first phase into the second phase via the plurality of apertures;
the apparatus also comprising a tunable refiner arranged to receive the emulsion from the membrane; and wherein said refiner comprises an inlet and an outlet wherein an adjustable opening adapted to converge flow of the emulsion and to break up droplets of the emulsion into a refined emulsion is located between the inlet and the outlet.

49.-53. (canceled)

54. A method of preparing a refined emulsion according to claim 46 wherein the apparatus is arranged to receive a first phase containing a liquid in the first volume and to receive a second phase in the second volume; the apparatus being adapted to generate an emulsion through egression of the first phase into the second phase via the plurality of apertures.

55. A method of preparing a refined emulsion according to claim 46 wherein the apparatus is arranged so that flow of the second phase in the second volume creates a shear field at the area of egression of the first phase, the shear field being in a direction substantially perpendicular to the direction of egression of the first phase.

56. A method of preparing a refined emulsion according to claim 46 wherein the membrane is tubular in shape and comprises a first end and a second end; wherein the first end is for receiving the second phase; and the refiner is coupled to the second end.

57.-78. (canceled)

79. A method of preparing a refined emulsion according to claim 46 wherein the apparatus is used in a continuous mode.

80. A method of preparing a refined emulsion according to claim 79 wherein the refiner comprises multiples inlets and/or multiple outlets.

81.-88. (canceled)

89. A method of preparing a refined emulsion, said method comprising using a membrane emulsification apparatus for dispersing a first phase in a second phase, wherein the membrane emulsification apparatus comprises a cross-flow apparatus for producing an emulsion or dispersion by dispersing a first phase in a second phase; said cross-flow apparatus comprising:
an outer tubular sleeve provided with a first inlet at a first end; an emulsion outlet; and a second inlet, distal from and inclined relative to the first inlet;
a tubular membrane provided with a plurality of pores and adapted to be positioned inside the tubular sleeve; and
optionally an insert adapted to be located inside the tubular membrane, said insert comprising an inlet end and an outlet end, each of the inlet end and an outlet end being provided with chamfered region; the chamfered region is provided with a plurality of orifices and a furcation plate;
the apparatus also comprising a refiner arranged to receive the emulsion from the membrane and wherein said refiner comprises an inlet and an outlet wherein an opening adapted to converge flow of the emulsion and to break up droplets of the emulsion into a refined emulsion is located between the inlet and the outlet;
wherein the refiner is an adjustable refiner.

90.-95. (canceled)
